(19) United States
(12) Patent Application Publication
(10) Pub. No.: US 2014/0230599 A1
(43) Pub. Date: Aug. 21, 2014

(54) Cable connection device

(71) Applicant: Chao Kung Chen, Changhua (TW)

(72) Inventor: Chao Kung Chen, Changhua (TW)

(21) Appl. No.: 14/261,439

(22) Filed: Apr. 25, 2014

(51) Int. Cl. F16C 1/10

(52) U.S. Cl. CPC F16C 1/101
USPC 74/502.6

(57) ABSTRACT

A cable connection device of a bicycle is provided with an outer barrel, an inner connecting member, and a tube, wherein an outer thread is arranged at one end of the tube, and a cone portion is arranged inside the end of the tube having the outer thread and tapered inwardly; an inner thread arranged at one end of the outer barrel is screwed with the outer thread of the tube, and a flange is arranged inside the end of the outer barrel away from the inner thread; and two flexible latches of the inner connecting member are disposed inside the cone portion, and an outer convex ring arranged between two ends of the inner connecting member is against the flange adjacent to the inner thread. The flexible latches are compressed by the cone portion to fasten one end of a cable passed through the tube.

### BACKGROUND OF THE INVENTION

1. Field of the Invention

The invention relates to bicycles, and more particularly to a cable connection device of a bicycle.

2. Description of Related Art

In general, the conventional brake cable of a bicycle with hydraulic brake must be connected with the pin inside the reservoir and the handlebar. Therefore, the reservoir must be arranged adjacent to the handlebar. In addition, the conventional brake cable is fixed connection. If a user wants to adjust the brake cable, it must be adjusted from the brake disc. It is not convenient to the user.

Thus, the need for improvement still exists.

### SUMMARY OF THE INVENTION

It is therefore one object of the invention to provide a cable connection device comprising an outer barrel, an inner connecting member, and a tube, wherein an outer thread is arranged at one end of the tube, and a cone portion is arranged inside the end of the tube having the outer thread and tapered inwardly; an inner thread arranged at one end of the outer barrel is screwed with the outer thread of the tube, and a flange is arranged inside the end of the outer barrel away from the inner thread; and two flexible latches of the inner connecting member are disposed inside the cone portion, and an outer convex ring arranged between two ends of the inner connecting member is against the flange adjacent to the inner thread wherein the two flexible latches are compressed by the cone portion to fasten one end of a cable passed through the tube.

The above and other objects, features and advantages of the invention will become apparent from the following detailed description taken with the accompanying drawings.

### BRIEF DESCRIPTION OF THE DRAWINGS

FIG. 1 is an exploded view of a cable connection device according to the invention;

FIG. 2 is a perspective view of the cable connection device; and

FIG. 3 is a cross sectional view of the cable connection device.

### DETAILED DESCRIPTION OF THE INVENTION

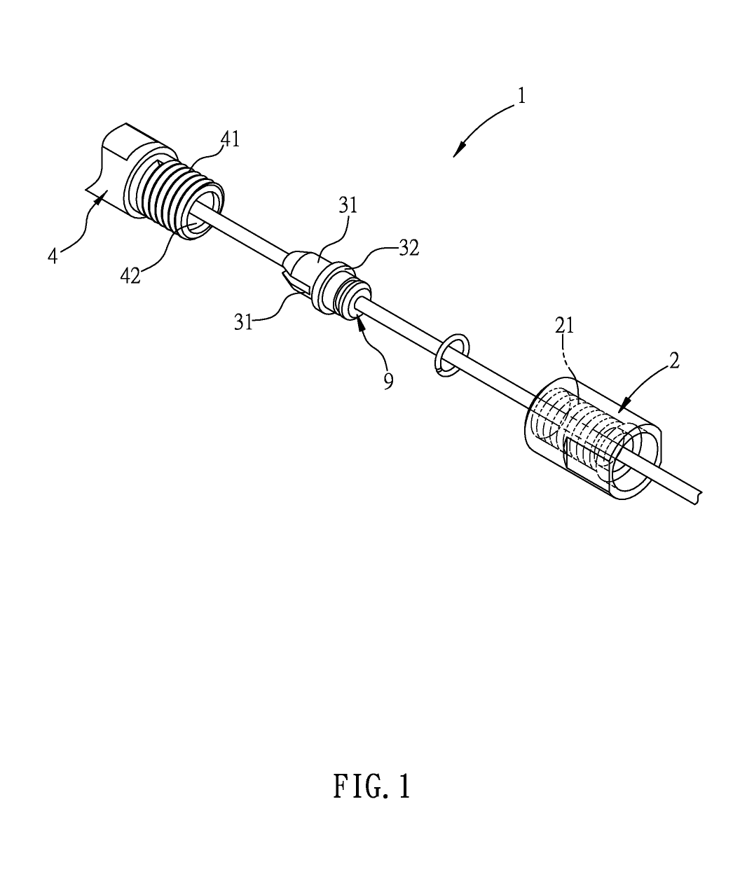

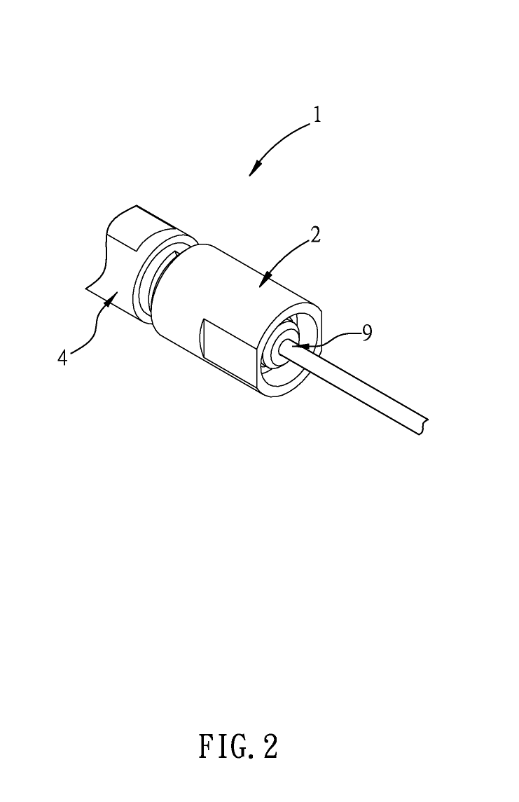

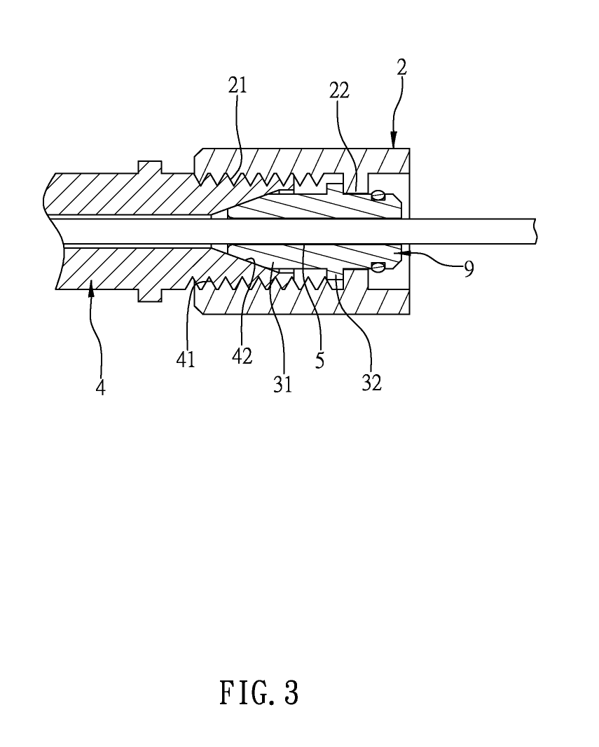

Referring to FIGS. 1 to 3, a cable connection device 1 of a bicycle (not shown) in accordance with the invention comprises an outer barrel 2, an inner connecting member 3, and a tube 4 as discussed in detail below.

An outer thread 41 may be arranged at one end of the tube 4, and a cone portion 42 may be arranged inside the end of the tube 4 having the outer thread 41 and tapered inwardly.

An inner thread 21 arranged at one end of the outer barrel 2 may be screwed with the outer thread 41 of the tube 4, and a flange 22 may be arranged inside the end of the outer barrel 2 away from the inner thread 21.

Two flexible latches 31 of the inner connecting member 3 may be disposed inside the cone portion 42, and an outer convex ring 32 arranged between two ends of the inner connecting member 3 may be against the flange 22 adjacent to the inner thread 21. The two flexible latches 31 may be compressed by the cone portion 42 to fastened one end of a cable 5 passed through the tube 4, and then the cable 5 may be arranged at center of the tube 4 to form a central pull structure for quick release.

Besides, the cable 5 may be a brake cable of a bicycle, and the tube 4 may be a pin with hollow structure of a hydraulic brake (not shown), but not limited thereto.

While the invention has been described in terms of preferred embodiments, those skilled in the art will recognize that the invention can be practiced with modifications within the spirit and scope of the appended claims.

What is claimed is:

1. A cable connection device for a bicycle, comprising:
an outer barrel;
an inner connecting member; and
a tube;
wherein an outer thread is arranged at one end of the tube;
wherein a cone portion is arranged inside the end of the tube having the outer thread and tapered inwardly;
wherein an inner thread arranged at one end of the outer barrel is screwed with the outer thread of the tube;
wherein a flange is arranged inside the end of the outer barrel away from the inner thread;
wherein two flexible latches of the inner connecting member are disposed inside the cone portion;
wherein an outer convex ring arranged between two ends of the inner connecting member is against the flange adjacent to the inner thread; and
wherein the flexible latches are compressed by the cone portion to fasten one end of a cable passed through the tube.

2. The cable connection device of claim 1, wherein the cable is a brake cable.
